(19) United States
(12) Patent Application Publication
(10) Pub. No.: US 2012/0126172 A1
(43) Pub. Date: May 24, 2012

(54) LUMINESCENT BORATE GLASS AND PREPARATION METHOD THEROF

(75) Inventors: Mingjie Zhou, Guangdong (CN); Qingtao Li, Guangdong (CN); Wenbo Ma, Guangdong (CN)

(73) Assignee: OCEAN'S KINGE LIGHTING SCIENCE & TECHNOLOGY CO., L, Guangdong (CN)

(21) Appl. No.: 13/386,656

(22) PCT Filed: Jul. 23, 2009
(86) PCT No.: PCT/CN09/72891

§ 371 Date: Jan. 23, 2012

(51) Int. Cl. C09K 11/80; C03B 32/00

(52) U.S. Cl. 252/301.4 F; 65/66; 65/32.5; 252/301.4 R

(57) ABSTRACT

A luminescent borate glass and a preparation method thereof are disclosed. The preparation method includes: weighing raw materials according to a composition of the formula: aM₂O.bY₂O₃.cAl₂O₃.d B₂O₃.eSiO₂.xCeO₂.y Tb₂O₃, wherein M represents at least one selected element from the group consisting of Na, K, and Li; a, b, c, d, e, x, and y are, by mole parts, 0˜20, 7˜15, 20˜40, 40˜60, 0˜15, 0.1˜1.5, 0.1˜3, respectively; melting the raw materials and then cooling and molding; and heat treating the molded glass to obtain the luminescent borate glass. The luminescent borate glass prepared according to the method has some advantages such as high luminous intensity, uniformity and stability.

### FIELD OF THE INVENTION

The present disclosure relates to luminescent materials, and more particularly relates to a luminescent borate glass and preparation method thereof.

### BACKGROUND OF THE INVENTION

At present, phosphor is a conventional luminescent material. The fluorescent materials used in the field emission devices are those phosphors used in conventional CRT (cathode ray tube) or projection TV CRT, such as sulfide-type, oxide-type, and sulfur-oxide-type. Sulfide-type and sulfur-oxide-type phosphor is conductive and it can exhibit an intense luminescent, however, it is tend to decompose sulfide gases during electron excitation, subsequently causing the cathode to deteriorate. Since sulfide and other precipitates may cover the phosphor, the luminous efficiency of phosphors and the life time of the field emission displays are tend to decrease.

As a new luminescent glass, the luminescent borate glass has gained more and more attention in such electronic fields as laser, optical communication, and optical amplifiers, for the feature of high transmittance. However, the conventional luminescent borate glass suffers from some disadvantages such as relatively low luminous intensity, poor uniformity and low stability.

Therefore, there is room for improvement within the art.

### SUMMARY OF THE INVENTION

In one aspect of present disclosure, a luminescent borate glass with high luminous intensity, uniformity and stability is desired to overcome the problems described above.

In one embodiment, a luminescent borate glass is provided with the chemical formula: aM₂O.bY₂O₃.cAl₂O₃.d B₂O₃.eSiO₂.xCeO₂ y Tb₂O₃, wherein M represents at least one element selected from the group consisting of Na, K, and Li; a, b, c, d, e, x, and y are, by mole parts, 0˜20, 7˜15, 20˜40, 40˜60, 0˜15, 0.1˜1.5, 0.1˜3, respectively.

In a preferable embodiment, a, b, c, d, e, x, and y are, by mole parts, 0˜15, 7˜12, 24˜37, 40˜55, 0˜10, 0.3˜1.2, 0.3˜1.5, respectively.

In a preferable embodiment, a, b, c, d, e, x, and y are, by mole parts, 4.5˜10.5, 7.5˜8, 26.25˜36, 42˜52, 0˜6, 0.5˜0.8, 0.4˜0.8, respectively.

In a preferable embodiment, the luminescent borate glass is capable of being radiated by UV having a wavelength in a range of 330˜380 nm.

In a preferable embodiment, the luminescent borate glass has an excitation wavelength in a range of 330˜380 nm, an emission wavelength in a range of 530˜560 nm, and a main emission wavelength of 540 nm when radiated by UV peaking at 366 nm.

A preparation method of a luminescent borate glass is also provided including:

weighing raw materials according to a composition of the formula: aM₂O.bY₂O₃.cAl₂O₃.d B₂O₃.eSiO₂.xCeO₂.y Tb₂O₃, wherein M represents at least one selected element from the group consisting of Na, K, and Li; a, b, c, d, e, x, and y are, by mole parts, 0˜20, 7˜15, 20˜40, 40˜60, 0˜15, 0.1˜1.5, 0.1˜3, respectively;

melting the raw materials and then cooling and molding; and

heat treating the molded glass to obtain the luminescent borate glass.

In a preferable embodiment, the melting temperature is in a range of 1580˜1750 ; the raw materials are melted at 1580˜1750 for 30 minutes, and then cooled and molded.

In a preferable embodiment, the heat treatment includes: heating the molded glass in reducing atmosphere at the temperature in a range of 650˜900 for 4˜12 hours, and cooling the molded glass to ambient temperature.

In a preferable embodiment, a, b, c, d, e, x, and y are, by mole parts, 0˜20, 7˜15, 20˜40, 40˜60, 0˜15, 0.1˜1.5, 0.1˜3, respectively.

In a preferable embodiment, a, b, c, d, e, x, and y are, by mole parts, 0˜15, 7˜12, 24˜37, 40˜55, 0˜10, 0.3˜1.2, 0.3˜1.5, respectively.

In a preferable embodiment, a, b, c, d, e, x, and y are, by mole parts, 4.5˜10.5, 7.5˜8, 26.25˜36, 42˜52, 0˜6, 0.5˜0.8, 0.4˜0.8, respectively.

The luminescent borate glass according to the present disclosure has some advantages such as high luminous intensity, uniformity and stability. In addition, the luminescent borate glass can be simply prepared into article, thus it is convenient to be packaged into devices. Accordingly, the luminescent borate glass with high luminous intensity is suitable as a light-emitting medium used in illumination or display field.

The preparation method of a luminescent borate glass according to the present disclosure is simple and its cost is low. The method also solves some problems such as low luminous intensity of the luminous active particles in the glass due to the limitation of glass preparation condition and glass structure.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flowchart of an embodiment of a preparation method of a luminescent borate glass;

FIG. 2 is an excitation and emission spectrum of the luminescent borate glass according to example 1 radiated by 366 nm UV using Shimadzu RF-5301 fluorescence spectrometer;

FIG. 3 is an excitation and emission spectrum of the luminescent borate glass according to example 2 radiated by 366 nm UV using Shimadzu RF-5301 fluorescence spectrometer;

FIG. 4 is an excitation and emission spectrum of the luminescent borate glass according to example 4 radiated by 366 nm UV using Shimadzu RF-5301 fluorescence spectrometer.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In a preferable embodiment, a luminescent borate glass is prepared with raw materials consisting essentially of: Al₂O₃; B₂O₃; at least one of oxide, carbonate, and oxalate of Y (Yttrium); at least one of oxide, carbonate, and oxalate of Ce (Cerium); at least one of oxide, carbonate, and oxalate of Tb (Terbium); SiO₂ and/or alkali metal carbonate. The luminescent borate glass includes a chemical formula: aM₂O.bY₂O₃.cAl₂O₃.d B₂O₃.eSiO₂.xCeO₂.y Tb₂O₃, wherein M represents at least one selected element from the group consisting of Na, K, and Li; a, b, c, d, e, x, and y are, by mole parts, 0˜20, 7˜15, 20˜40, 40˜60, 0˜15, 0.1˜1.5, 0.1˜3, respectively.

As known to a person having ordinary skill in the art that the above mentioned raw materials are only preferred raw materials. Besides that, the raw materials below are available from other materials by heating, oxidation, or other chemical reactions, or from the minerals containing: Al₂O₃; B₂O₃; at least one of oxide, carbonate, and oxalate of Y (Yttrium); at least one of oxide, carbonate, and oxalate of Ce (Cerium); at least one of oxide, carbonate, and oxalate of Tb (Terbium); SiO₂ and/or alkali metal carbonate.

In an illustrated embodiment, Na₂CO₃, Y₂O₃, Al₂O₃, B₂O₃, SiO₂, CeO₂ and Tb2O3are taken as exemplified raw materials. Appropriate raw materials may be chosen by the person having ordinary skill in the art to obtain the luminescent borate glass by chemical reaction without any further work, the raw materials may be K₂CO₃, Li₂CO₃, and a mixture of them and Na₂CO₃; at least one of oxide, carbonate, and oxalate of Y (Yttrium); at least one of oxide, carbonate, and oxalate of Ce (Cerium); at least one of oxide, carbonate, and oxalate of Tb (Terbium); and reactants which can generate Al₂O₃, B₂O₃. In the preferred embodiment, the purity of the raw materials is no less than AR.

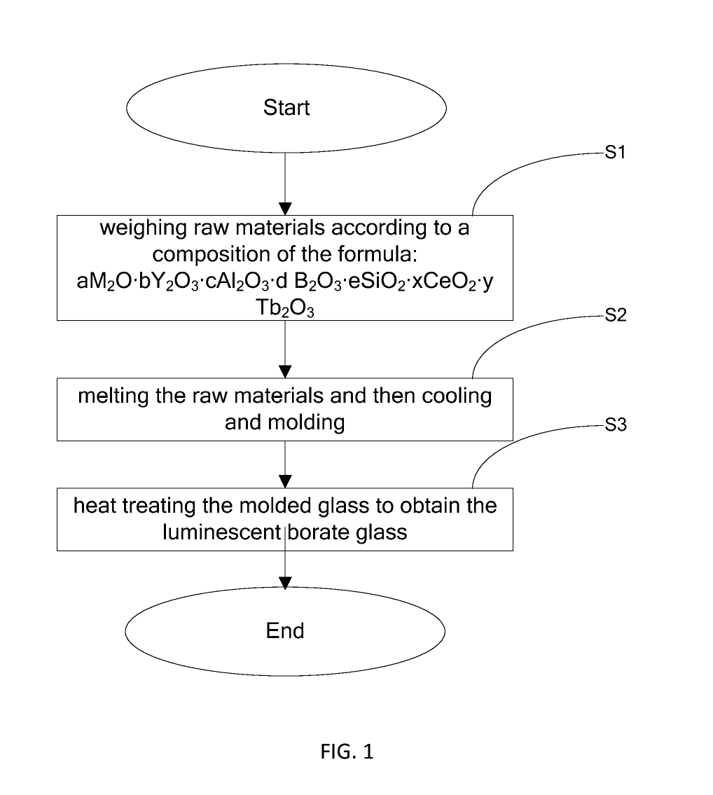

Referring to FIG. 1, an embodiment of a preparation method of a luminescent borate glass includes following steps.

Step S1, raw materials are weighted according to mole parts of each element of the chemical formula: aM₂O.bY₂O₃.cAl₂O₃.d B₂O₃.eSiO₂.xCeO₂.y Tb₂O₃, wherein M represents at least one selected element from the group consisting of Na, K, and Li; a, b, c, d, e, x, and y are, by mole parts, 0˜20, 7˜15, 20˜40, 40˜60, 0˜15, 0.1˜1.5, 0.1˜3, respectively.

Step S2, the raw materials are melted and then cooled and molded.

For example, the raw materials are melted at 1580˜1750 for 30 minutes. The melted glass is then poured into a stainless steel plate to be cooled and molded.

Step S3, the molded glass is heat treated to obtain the luminescent borate glass.

The heat treatment includes: placing the molded glass in a reducing environment and heating the molded glass at a temperature in a range of 650˜900 for 4˜12 hours, and then cooling the molded glass to ambient temperature.

A number of examples of the different composition and the preparation method of the luminescent borate glass will be described in more detail.

### Example 1

According to the chemical formula: 15Na₂O-7.75Y₂O₃-26.25Al₂O₃-50B₂O₃-0.5CeO₂-1Tb₂O₃ (mole part), 6.83 g of Na₂CO₃, 7.53 g of Y₂O₃, 26.62 g of B₂O₃, 11.52 g of Al₂O₃, 1.6 g of Tb₂O₃, and 0.36 g of CeO₂ are weighed and ball milled or mortar milled to obtain a uniform mixture. The milled raw materials are introduced into an alumina crucible and heated at a high temperature of 1630 for 30 minutes, and then the melted glass is poured into the stainless steel plate to be cooled and molded. The molded glass is placed in reducing atmosphere (95% by volume of N₂ and 5% by volume of H₂), and heated at 700 for 4 hours, and the luminescent borate glass with the chemical formula 15Na₂O-7.75Y₂O₃-26.25Al₂O₃-50B₂O₃-0.5CeO₂-1Tb₂O₃ is finally obtained.

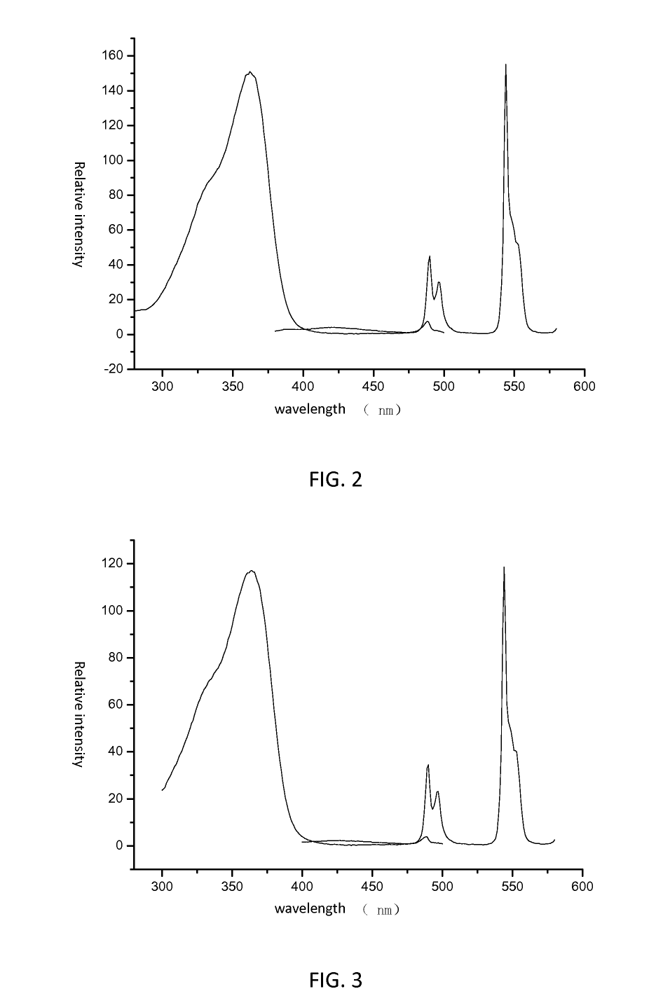

The obtained luminescent borate glass is capable of being radiated by UV (Ultra Violet) with wavelength in a range of 330˜380 nm. When radiated by UV peaking at 366 nm, the obtained luminescent borate glass exhibits an intense green light. Referring to FIG. 2, the luminescent borate glass has an excitation wavelength in a range of 330˜380 nm, an emission wavelength in a range of 530˜560 nm, and a main emission wavelength of 540 nm.

In alternative embodiments, the Na₂CO₃ may be replaced by K₂CO₃, Li₂CO₃, Na₂C₂O₄, K₂C₂O₄, or their mixture.

### Example 2

According to the chemical formula: 12Y₂O₃-37Al₂O₃-50B₂O₃-0.5CeO₂-1Tb₂O₃ (mole part), 7.8 g of Y₂O₃, 17.8 g of B₂O₃, 10.86 g of Al₂O₃, 0.24 g of CeO₂, and 1.07 g of Tb₂O₃ are weighed and ball milled or mortar milled to obtain a uniform mixture. The milled raw materials are introduced into an alumina crucible and heated at a high temperature of 1700 for 30 minutes, and then the melted glass is poured into the stainless steel plate to be cooled and molded. The molded glass is placed in reducing atmosphere (95% by volume of N₂ and 5% by volume of H₂) and heated at 800 for 5 hours, and the luminescent borate glass with the chemical formula 12Y₂O₃-37Al₂O₃-50B₂O₃-0.5CeO₂-1Tb₂O₃ is finally obtained.

The obtained luminescent borate glass is capable of being radiated by UV (Ultra Violet) with wavelength in a range of 330˜380 nm. When radiated by UV peaking at 366 nm, the luminescent borate glass exhibits an intense green light. Referring to FIG. 3, the obtained luminescent borate glass has an excitation wavelength in a range of 330˜380 nm, an emission wavelength in a range of 530˜560 nm, and a main emission wavelength of 544 nm.

In alternative embodiments, the oxide of Y, Ce, and Tb may be replaced by at least one of their carbonate or oxalate.

### Example 3

According to the chemical formula: 10Y₂O₃-37Al₂O₃-40B₂O₃-10SiO₂-0.5CeO₂ -3Tb₂O₃ (mole part), 12.78 g of Y₂O₃, 27.99 g of B₂O₃, 21.35 g of Al₂O₃, 3.39 g of SiO₂, 0.48 g of CeO₂, and 6.21 g of Tb₂O₃ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂) to 850 for 7 hours, and the luminescent borate glass with the chemical formula 10Y₂O₃-37Al₂O₃-40B₂O₃-10SiO₂-0.5CeO₂-3Tb₂O₃ is finally obtained.

### Example 4

According to the chemical formula: 15Na₂O-7Y₂O₃-26.25Al₂O₃-49.5B₂O₃-1.5 CeO₂-1Tb₂O₃ (mole part), 6.86 g of Na₂CO₃, 6.82 g of Y₂O₃, 26.44 g of B₂O₃, 11.56 g of Al₂O₃, 1.11 g of CeO₂, and 1.61 g of Tb₂O₃ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂) and heated at 650 for 12 hours, and the luminescent borate glass with the chemical formula 15Na₂O-7Y₂O₃-26.25Al₂O₃-49.5B₂O₃-1.5 CeO₂-1Tb₂O₃ is finally obtained.

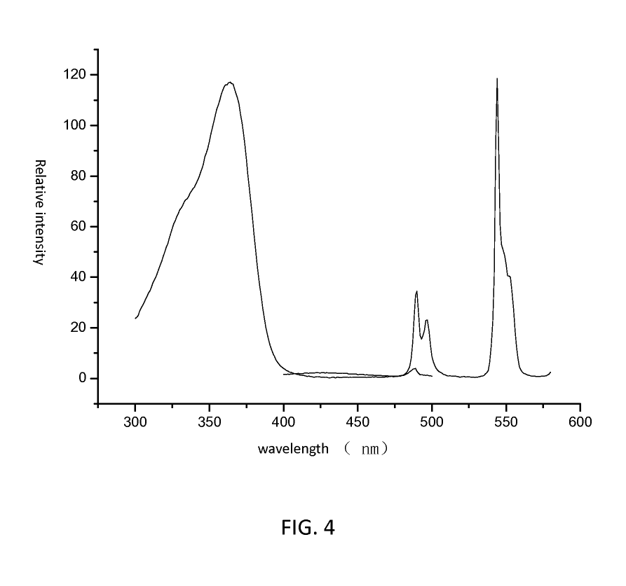

The obtained luminescent borate glass is capable of being radiated by UV (Ultra Violet) with wavelength in a range of 330˜380 nm. When radiated by UV peaking at 364 nm, the luminescent borate glass exhibits an intense 1 green light. Referring to FIG. 4, the obtained luminescent borate glass has an excitation wavelength in a range of 330˜380 nm, an emission wavelength in a range of 530˜560 nm, and a main emission wavelength of 544 nm.

### Example 5

According to the chemical formula: 20Na₂O-8Y₂O₃-24Al₂O₃-46.5B₂O₃-1.5CeO₂-1.2Tb₂O₃ (mole part), 6.79 g of Na₂CO₃, 5.79 g of Y₂O₃, 18.03 g of B₂O₃, 7.84 g of Al₂O₃, 1.4 g of Tb₂O₃, and 0.82 g of CeO₂ are weighed and ball milled or mortar milled to obtain a uniform mixture. The milled raw materials are introduced into an alumina crucible and heated at a high temperature of 1630 for 30 minutes, and then the melted glass is poured into the stainless steel plate to be cooled and molded. The molded glass is placed in reducing atmosphere (95% by volume of N₂ and 5% by volume of H₂), and heated at 650 for 10 hours, and the luminescent borate glass with the chemical formula 20Na₂O-8Y₂O₃-24Al₂O₃-46.5B₂O₃-1.5CeO₂-1.2Tb₂O₃ is finally obtained.

### Example 6

According to the chemical formula: 10.5Na₂O-7.5Y₂O₃-20Al₂O₃-60B₂O₃-0.8CeO₂-1.5Tb₂O₃ (mole part), 6.01 g of Na₂CO₃, 9.15 g of Y₂O₃, 40.11 g of B₂O₃, 11.02 g of Al₂O₃, 3.02 g of Tb₂O₃, and 0.74 g of CeO₂ are weighed and ball milled or mortar milled to obtain a uniform mixture. The milled raw materials are introduced into an alumina crucible and heated at a high temperature of 1630 for 30 minutes, and then the melted glass is poured into the stainless steel plate to be cooled and molded. The molded glass is placed in reducing atmosphere (95% by volume of N₂ and 5% by volume of H₂), and heated at 750 for 6 hours, and the luminescent borate glass with the chemical formula 10.5Na₂O-7.5Y₂O₃-20Al₂O₃-60B₂O₃- 0.8CeO₂-1.5Tb₂O₃ is finally obtained.

### Example 7

According to the chemical formula: 4.5Na₂O-10Y₂O₃-40Al₂O₃-45B₂O₃-0.3Ce-O₂-0.5Tb₂O₃ (mole part), 2.38 g of Na₂CO₃, 11.3 g of Y₂O₃, 27.86 g of B₂O₃, 20.42 g of Al₂O₃, 0.93 g of Tb₂O₃, and 0.25 g of CeO₂ are weighed and ball milled or mortar milled to obtain a uniform mixture. The milled raw materials are introduced into an alumina crucible and heated at a high temperature of 1750 for 30 minutes, and then the melted glass is poured into the stainless steel plate to be cooled and molded. The molded glass is placed in reducing atmosphere (95% by volume of N₂ and 5% by volume of H₂), and heated at 750 t for 6 hours, and the luminescent borate glass with the chemical formula 4.5Na₂O-10Y₂O₃-40Al₂O₃-45B₂O₃-0.3CeO₂-0.5Tb₂O₃ is finally obtained.

### Example 8

According to the chemical formula: 11Y₂O₃-33Al₂O₃-55B₂O₃-0.3CeO₂-0.8Tb₂O₃ (mole part), 12.39 g of Y₂O₃, 33.92 g of B₂O₃, 16.78 g of Al₂O₃, 1.49 g of Tb₂O₃, and 0.25 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 900 for 12 hours, and the luminescent borate glass with the chemical formula 11Y₂O₃-33Al₂O₃-55B₂O₃-0.3CeO₂-0.8Tb₂O₃ is finally obtained.

### Example 9

According to the chemical formula: 12Y₂O₃-36Al₂O₃-52B₂O₃-0.1CeO₂-0.1Tb₂O₃ (mole part), 13.47 g of Y₂O₃, 31.97 g of B₂O₃, 18.25 g of Al₂O₃, 0.18 g of Tb₂O₃, and 0.08 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 700 for 6 hours, and the luminescent borate glass with the chemical formula 12Y₂O₃-36Al₂O₃-52B₂O₃-0.1CeO₂-0.1Tb₂O₃ is finally obtained.

### Example 10

According to the chemical formula: 15Na₂O-7.5Y₂O₃-26.5Al₂O₃-50B₂O₃-0.3CeO₂-0.7Tb₂O₃ (mole part), 2.38 g of Na₂CO₃, 11.3 g of Y₂O₃, 27.86 g of B₂O₃, 20.42 g of Al₂O₃, 0.93 g of Tb₂O₃, and 0.25 g of CeO₂ are weighed and ball milled or mortar milled to obtain a uniform mixture. The milled raw materials are introduced into an alumina crucible and heated at a high temperature of 1750 for 30 minutes, and then the melted glass is poured into the stainless steel plate to be cooled and molded. The molded glass is placed in reducing atmosphere (95% by volume of N₂ and 5% by volume of H₂), and heated at 750 for 6 hours, and the luminescent borate glass with the chemical formula 15Na₂O-7.5Y₂O₃-26.5Al₂O₃-50B₂O₃-0.3CeO₂-0.7Tb₂O₃ is finally obtained.

### Example 11

According to the chemical formula: 10Y₂O₃-37Al₂O₃-50B₂O₃-0.5CeO₂-3Tb₂O₃ (mole part), 6.33 g of Y₂O₃, 17.33 g of B₂O₃, 10.58 g of Al₂O₃, 3.14 g of Tb₂O₃, and 0.24 g of CeO₂ are weighed and ball milled or mortar milled to obtain a uniform mixture. The milled raw materials are introduced into an alumina crucible and heated at a high temperature of 1680 for 30 minutes, and then the melted glass is into the stainless steel plate to be cooled and molded. The molded glass is placed in reducing atmosphere (95% by volume of N₂ and 5% by volume of H₂), and heated at 850 for 7 hours, and the luminescent borate glass with the chemical formula 10Y₂O₃-37Al₂O₃-50B₂O₃-0.5CeO₂-3Tb₂O₃ is finally obtained.

### Example 12

According to the chemical formula: 10Na₂O-7Y₂O₃-25Al₂O₃-42B₂O₃-15SiO₂-0.3CeO₂-0.5Tb₂O₃ (mole part), 7.21 g of Na₂CO₃, 10.76 g of Y₂O₃, 35.37 g of B₂O₃, 17.35 g of Al₂O₃, 6.13 g of SiO₂, 1.24 g of Tb₂O₃, and 0.34 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 780 for 6 hours, and the luminescent borate glass with the chemical formula 10Na₂O-7Y₂O₃-25Al₂O₃-42B₂O₃-15SiO₂-0.3CeO₂-0.5Tb₂O₃ is finally obtained.

### Example 13

According to the chemical formula: 15Na₂O-8Y₂O₃-24Al₂O₃-46B₂O₃-6SiO₂-0.3CeO₂-0.5Tb₂O₃ (mole part), 10.61 g of Na₂CO₃, 12.06 g of Y₂O₃, 37.99 g of B₂O₃, 16.34 g of Al₂O₃, 2.4 g of SiO₂, 1.21 g of Tb₂O₃, and 0.34 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 780 for 5 hours, and the luminescent borate glass with the chemical formula 15Na₂O-8Y₂O₃-24Al₂O₃-46B₂O₃-6SiO₂-0.3CeO₂-0.5Tb₂O₃ is finally obtained.

### Example 14

According to the chemical formula: 12Y₂O₃-35Al₂O₃-50B₂O₃-1.2CeO₂-1.8Tb₂O₃ (mole part), 15.3 g of Y₂O₃, 34.91 g of B₂O₃, 20.14 g of Al₂O₃, 3.71 g of Tb₂O₃, and 1.16 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 750 for 4 hours, and the luminescent borate glass with the chemical formula 12Y₂O₃-35Al₂O₃-50B₂O₃-1.2CeO₂-1.8Tb₂O₃ is finally obtained.

### Example 15

According to the chemical formula: 10Na₂O-15Y₂O₃-25Al₂O₃-40B₂O₃-10SiO₂-0.2CeO₂-0.4Tb₂O₃ (mole part), 4.19 g of Na₂CO₃, 13.4 g of Y₂O₃, 19.57 g of B₂O₃, 10.08 g of Al₂O₃, 2.37 g of SiO₂, 0.57 g of Tb₂O₃, and 0.06 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 780 for 5 hours, and the luminescent borate glass with the chemical formula 10Na₂O-15Y₂O₃-25Al₂O₃-40B₂O₃-10SiO₂-0.2CeO₂-0.4Tb₂O₃ is finally obtained.

### Example 16

According to the chemical formula: 15Na₂O-8Y₂O₃-24Al₂O₃-46B₂O₃-3SiO₂-0.3CeO₂-0.5Tb₂O₃ (mole part), 10.61 g of Na₂CO₃, 12.06 g of Y₂O₃, 37.99 g of B₂O₃, 16.34 g of Al₂O₃, 1.2 g of SiO₂, 1.21 g of Tb₂O₃, and 0.34 g of CeO₂ are weighed and ball milled or mortar milled to obtain a uniform mixture. The milled raw materials are introduced into an alumina crucible and heated at a high temperature of 1680 for 30 minutes, and then the melted glass is poured into the stainless steel plate to be cooled and molded. The molded glass is placed in reducing atmosphere (95% by volume of N₂ and 5% by volume of H₂), and heated at 780 for 5 hours, and the luminescent borate glass with the chemical formula 15Na₂O-8Y₂O₃-24Al₂O₃-46B₂O₃-3SiO₂-0.3CeO₂-0.5Tb₂O₃ is finally obtained.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

What is claimed is:

1. A luminescent borate glass, comprising a composition with the chemical formula:
aM₂O.bY₂O₃.cAl₂O₃.d B₂O₃.eSiO₂.xCeO₂.y Tb₂O₃,
wherein M represents at least one element selected from the group consisting of Na, K, and Li;
a, b, c, d, e, x, and y are, by mole parts, 0˜20, 7˜15, 20˜40, 40˜60, 0˜15, 0.1˜1.5, 0.1˜3, respectively.

2. The luminescent borate glass according to claim 1, wherein a, b, c, d, e, x, and y are, by mole parts, 0˜15, 7˜12, 24˜37, 40˜55, 0˜10, 0.3˜1.2, 0.3˜1.5, respectively.

3. The luminescent borate glass according to claim 2, wherein a, b, c, d, e, x, and y are, by mole parts, 4.5˜10.5, 7.5˜8, 26.25˜36, 42˜52, 0˜6, 0.5˜0.8, 0.4˜0.8, respectively.

4. The luminescent borate glass according to any of claims 1 to 3, wherein the luminescent borate glass is capable of being radiated by UV with wavelength in a range of 330˜380 nm.

5. The luminescent borate glass according to claim 4, wherein the luminescent borate glass has an excitation wavelength in a range of 330˜380 nm, an emission wavelength in a range of 530˜560 nm, and a main emission wavelength of 540 nm when radiated by UV peaking at 366 nm.

6. A preparation method of a luminescent borate glass, comprising:
weighing raw materials according to a composition of the formula:
aM₂O.bY₂O₃.cAl₂O₃.d B₂O₃.eSiO₂.xCeO₂.y Tb₂O₃, wherein M represents at least one selected element from the group consisting of Na, K, and Li; a, b, c, d, e, x, and y are, by mole parts, 0˜20, 7˜15, 20˜40, 40˜60, 0˜15, 0.1˜1.5, 0.1˜3, respectively;
melting the raw materials and then cooling and molding; and
heat treating the molded glass to obtain the luminescent borate glass.

7. The preparation method according to claim 6, wherein the melting temperature is in a range of 1580˜1750 ; the raw materials are melted at 1580˜1750 for 30 minutes, and then cooled and molded.

8. The preparation method according to claim 7, wherein the heat treatment comprises:
heating the molded glass in reducing atmosphere at the temperature in a range of 650˜900 for 4˜12 hours, and cooling the molded glass to ambient temperature.

9. The preparation method according to claim 6, wherein a, b, c, d, e, x, and y are, by mole parts, 0˜20, 7˜15, 20˜40, 40˜60, 0˜15, 0.1˜1.5, 0.1˜3,respectively.

10. The preparation method according to claim 9, wherein a, b, c, d, e, x, and y are, by mole parts, 0˜15, 7˜12, 34˜37, 40˜55, 0˜10, 0.3˜1.2, 0.3˜1.5, respectively.

11. The preparation method according to claim 10, wherein a, b, c, d, e, x, and y are, by mole parts, 4.5˜10.5, 7.5˜8, 26.25˜36, 42˜52, 0˜6, 0.5˜0.8, 0.4˜0.8, respectively.
